(19) United States
(12) Patent Application Publication
(10) Pub. No.: US 2006/0284338 A1
(43) Pub. Date: Dec. 21, 2006

(54) Ballistics panel, structure, and associated methods

(75) Inventors: David Walter Brown, Mt. Juliet, TN (US); William Marcus Ghetti, Acworth, GA (US)

Correspondence Address: BRACEWELL & GIULIANI LLP, P.O. BOX 61389, HOUSTON, TX, 77208-1389, US

(73) Assignee: The Brown Idea Group, LLC, Mt. Juliet, TN (US)

(21) Appl. No.: 11/183,384

(22) Filed: Jul. 18, 2005

Related U.S. Application Data
(60) Provisional application No. 60/646,269, filed on Jan. 24, 2005.

(51) Int. Cl. B29C 43/02

(52) U.S. Cl. 264/258; 264/553; 264/571; 264/324; 264/277; 264/271.1

(57) ABSTRACT

A ballistic structure and associated methods of forming and using the same are provided. An embodiment of method of forming a ballistic structure includes positioning at least one layer of a plurality of substantially solid objects to overlie and contact a plurality of fabric layers. The plurality of objects is being positioned in each layer so that spacing occurs between each of the plurality of objects. The method can also include positioning a resin material in the spacing between each of the plurality of objects and to contact at least an innermost layer of the plurality of woven fabrics and heating the resin material to thereby cure the resin material.

### RELATED APPLICATIONS

The present application claims priority to and the benefit of U.S. Provisional Patent Application Ser. No. 60/646,269 filed on Jan. 24, 2005 titled “Ballistics Panel, Structure, and Associated Methods” and which is incorporated herein by reference in its entirety. The present application is also related to co-pending U.S. Non-Provisional Patent Application by the same inventors titled “Ballistics Panel, Structure, and Associated Methods” filed the same day as this application, and which is also incorporated herein by reference in its entirety.

### BACKGROUND OF THE INVENTION

1. Field of the Invention

The present invention relates to ballistics and, more particularly, to panels, clothing and other structures to reduce impact of ballistics and related methods.

2. Description of Related Art

Armor and other protective materials have been used for years to protect individuals and equipment from damage by ballistics, projectiles, and other weapons. Over the years, these ballistics, projectiles, and other weapons have increased in strength and accuracy in launch toward a target. Protective clothing and other types of body armor have been developed with the use of artificial fibers such as Nylon, Kevlar, and Spectra. More recently, it has been recognized that use of non-woven material in different arrangements can have some benefits such as shown in U.S. Pat. No. 5,736,474 by Thomas titled “Multi-Structured Ballistic Material.” Applicants, however, have recognized that any strength advantages of such fabric materials may not be as beneficial as desired. For example, although such fabric materials may be breathable to certain degree, such fabric materials may have difficulty stopping high energy ballistic or armor piercing rounds and may be difficult to manufacture.

Other ballistic armor systems, such as shown in U.S. Pat. No. 4,179,979 by Cook et al. titled “Ballistic Armor System,” which focus on a type of geometric layering using a type of tensional restraint of hard geometric objects in these layers. Applicants have also recognized that such armor or panels also may be difficult to manufacture and that a simpler and more effective solution for ballistic armor is still desired and needed for many applications and that the type of objects described may have geometric alignment limitations which need enhancement.

### SUMMARY OF THE INVENTION

In view of the foregoing, embodiments of the present invention advantageously provide a ballistic panel and other structures with enhanced strength or projectile protection capabilities. Embodiments of the present invention also advantageously provide ballistic panels and other structures that are relatively easy and inexpensive to manufacture, lightweight, and deflect or destroy high-energy projectiles such as found with many armor piercing type of bullets. Embodiments of the present invention also further provide enhanced methods of forming ballistic panels or other structures using known compounds, objects, and fabrics which enhance performance characteristics, are low cost, and can reach desired levels of protectiveness for a wide variety of applications.

More particularly, an embodiment of a ballistic panel, or other structure, according to the present invention includes a first plurality of fabric layers of woven fiber material and at least one layer of a plurality of substantially solid objects positioned to overlie the first plurality of fabric layers. The plurality of objects is positioned in each layer so that contact of each of the plurality of objects to adjacent objects occurs and yet spacing occurs between each of the plurality of objects. The panel also includes a polymeric material positioned in the spacing between each of the plurality of objects and a second plurality of fabric layers of woven fiber material positioned to overlie the polymeric material and the plurality of spherical-shaped objects.

For armor piercing projectiles or ballistics, for example, embodiments of multiple layers of a plurality of objects in a ballistic panel or other structure can advantageously be used to more effectively spread the energy received from such a projectile. A second and third layer can be added, e.g., preferably tight packed or nested, to stepwise increase or enhance protectiveness of the panel. Also, as layers of the objects are increased, layers of fabric material can be decreased if desired. For example, in an embodiment of a single layer of a ballistic panel according to the present invention, 14 layers of woven fabric material, such as Kevlar, Twaron, Spectra or other Aramid fiber-type of material, can be used. On the other hand, if two spherical layers are used in an embodiment of a ballistic panel, then only 6 layers of woven fabric material can be used if desired.

Another embodiment of a ballistic structure according to the present invention includes a plurality of fabric layers of woven fiber material. The plurality of fabric layers also includes an innermost woven layer having spacing between fibrous strands of fabric. The structure also includes at least one layer of a plurality of substantially solid objects positioned adjacent the innermost layer of the plurality of fabric layers. The plurality of objects being positioned in each layer so that contact of each of the plurality of objects to adjacent objects occurs and yet spacing occurs between each of the plurality of objects. The panel further includes a polymeric material positioned in the spacing between each of the plurality of objects and the spacing between fibrous strands of and contacting the innermost layer.

Also, embodiments of methods of forming a ballistic panel according to the present invention are also advantageously provided. An embodiment of a method of forming a ballistic panel, for example, includes positioning a plurality of woven fabric layers in association with a mold and positioning at least one layer of a plurality of substantially solid objects adjacent and to contact at least one of the first plurality of fabric layers. The plurality of objects can be positioned in each layer so that spacing occurs between each of the plurality of spherical-shaped objects. The method can also include positioning a polymeric resin material in the spacing between each of the plurality of objects, heating the resin material, and, if desired, positioning a second plurality of fabric layers of woven fiber material adjacent the polymeric material and the plurality of objects. Additionally, either prior to, in conjunction with, or within the resin material, the method can also include adding substantially hollow microspheres or other hollow micro-objects to the plurality of substantially solid objects.

For example, consistently tightly nesting or packing each of the plurality of substantially solid objects, e.g., spheres, half-spheres, pills, and pellets, in one or more layers in embodiments of panels, structures, and related methods, enhanced performance characteristic for destroying and/or reducing the energy of projectiles can be achieved in a more cost effective manner. Also, for example, by using woven fabric layers and polymeric resin in embodiments, weight can be substantially reduced for many protective applications. Further, for example, the hollow microspheres or other hollow objects can also further reduce the weight of embodiments of a panel or structure according to the present invention.

### BRIEF DESCRIPTION OF THE DRAWINGS

The patent or application file contains at least one drawing executed in color. Copies of this patent or patent application publication with color drawings will be provided by the Office upon request and payment of the necessary fee.

Some of the features and benefits of the present invention having been stated, others will become apparent as the description proceeds when taken in conjunction with the accompanying drawings, in which:

FIG. 1 is an enlarged and fragmentary sectional view of a ballistic panel according to an embodiment of the present invention;

FIG. 2A is an enlarged and fragmentary sectional view of a projectile striking a ballistic panel according to another embodiment of the present invention;

FIG. 2B is an enlarged and fragmentary sectional view of a projectile striking a ballistic panel according to yet another embodiment of the present invention;

FIG. 3 is a perspective view of a method of forming a ballistic panel according to an embodiment of the present invention;

FIG. 4 is a perspective view of a method of forming a ballistic panel according to an embodiment of the present invention;

FIG. 5 is a perspective view of a method of forming a ballistic panel according to an embodiment of the present invention;

FIG. 6 is a perspective view of a method of forming a ballistic panel according to an embodiment of the present invention;

FIG. 7 is a perspective view of a method of forming a ballistic panel according to an embodiment of the present invention;

FIG. 8 is a perspective view of a method of forming a ballistic panel according to an embodiment of the present invention;

FIG. 9 is a perspective view of a method of forming a ballistic panel according to an embodiment of the present invention;

FIG. 10 is a perspective view of a method of forming a ballistic panel according to an embodiment of the present invention;

FIG. 11 is a perspective view of a method of forming a ballistic panel according to an embodiment of the present invention;

FIG. 12A is a fragmentary exploded view of a ballistic panel according to an embodiment of the present invention;

FIG. 12B is a fragmentary exploded view of a ballistic panel according to another embodiment of the present invention;

FIG. 13 is an enlarged sectional view of a ballistic panel according to an embodiment of the present invention;

FIG. 14 is a perspective view of a projectile having been destroyed using a ballistic panel according to an embodiment of the present invention;

FIG. 15 is a perspective view of a ballistic panel according to another embodiment of the present invention;

FIG. 16 is a perspective view of a ballistic panel according to another embodiment of the present invention;

FIG. 17 is a perspective view of a ballistic panel according to yet another embodiment of the present invention;

FIG. 18 is a perspective view of a method of forming a ballistic panel according to an embodiment of the present invention as also shown in FIG. 3;

FIG. 19 is a top plan view of a method of forming a ballistic panel according to an embodiment of the present invention as also shown in FIG. 4;

FIG. 20 is a perspective view of a method of forming a ballistic panel according to an embodiment of the present invention as also shown in FIG. 5;

FIG. 21 is a perspective view of a method of forming a ballistic panel according to an embodiment of the present invention as also shown in FIG. 6;

FIG. 22 is a top plan view of a method of forming a ballistic panel according to an embodiment of the present invention as also shown in FIG. 7;

FIG. 23 is a perspective view of a method of forming a ballistic panel according to an embodiment of the present invention as also shown in FIG. 8;

FIG. 24 is a perspective view of a method of forming a ballistic panel according to an embodiment of the present invention as also shown in FIG. 9;

FIG. 25 is a perspective view of a method of forming a ballistic panel according to an embodiment of the present invention as also shown in FIG. 10;

FIG. 26 is a perspective view of a method of forming a ballistic panel according to an embodiment of the present invention as also shown in FIG. 11;

FIG. 27 is a perspective view of a projectile having been destroyed using a ballistic panel according to an embodiment of the present invention as also shown in FIG. 14;

FIG. 28 is a fragmentary perspective view of a ballistic panel according to another embodiment of the present invention as also shown in FIG. 15;

FIG. 29 is a perspective view of a ballistic panel according to another embodiment of the present invention as also shown in FIG. 16; and

FIG. 30 is a perspective view of a ballistic panel according to yet another embodiment of the present invention as also shown in FIG. 17.

### DETAILED DESCRIPTION

The present invention now will be described more fully hereinafter with reference to the accompanying drawings in which embodiments of the invention are shown. This invention, however, may be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout, and prime or double prime notation where used in association with numbers indicates like elements in alternative embodiments.

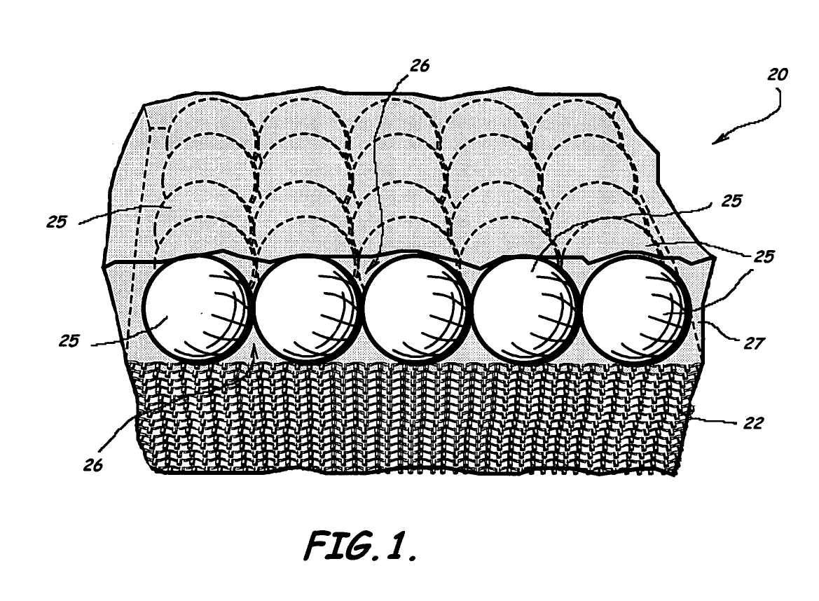

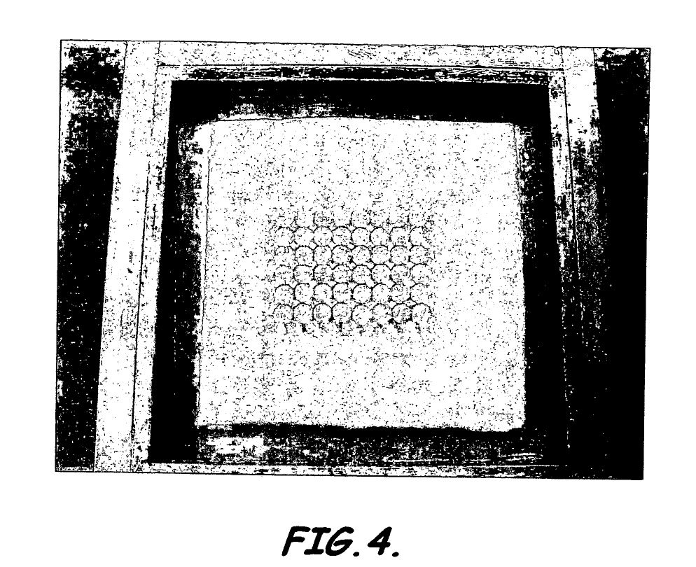

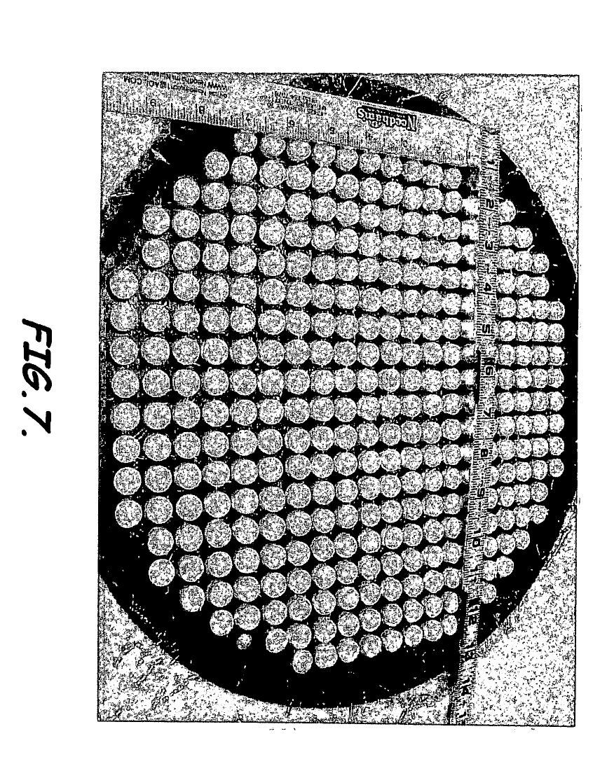

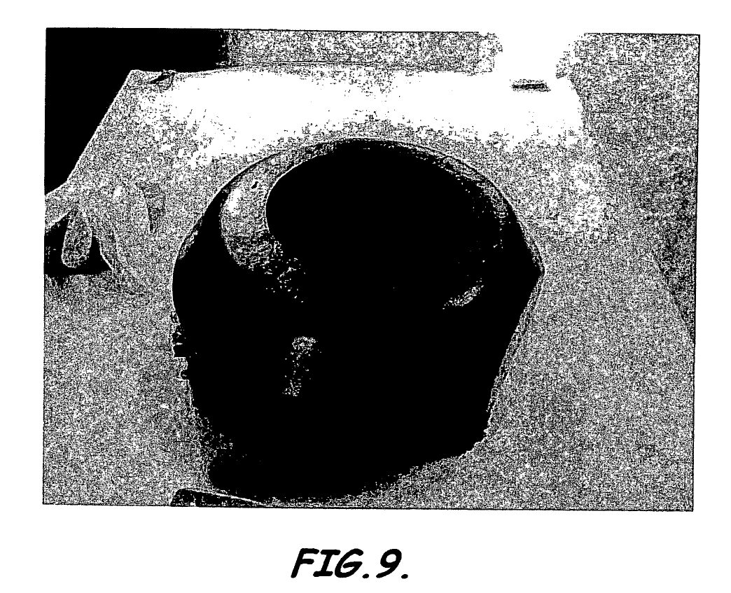

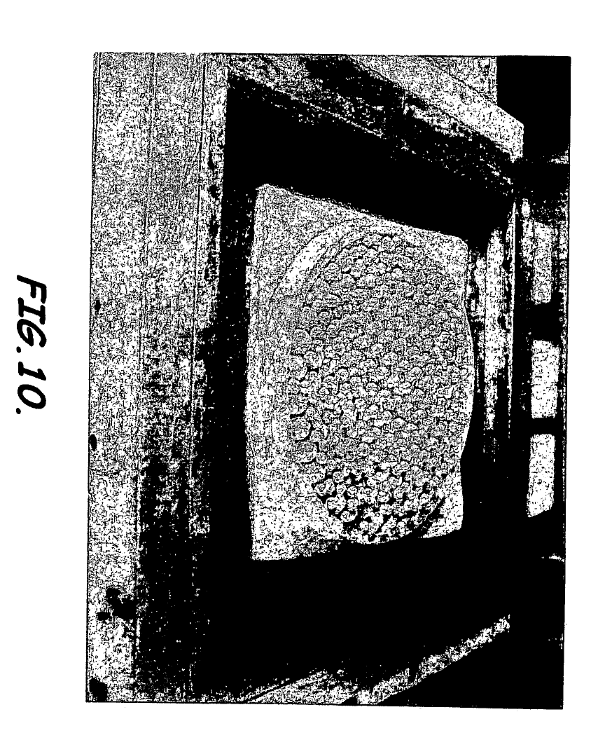

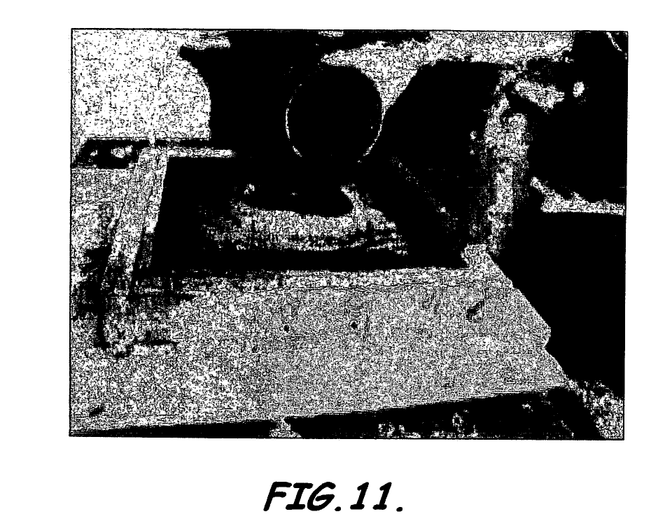

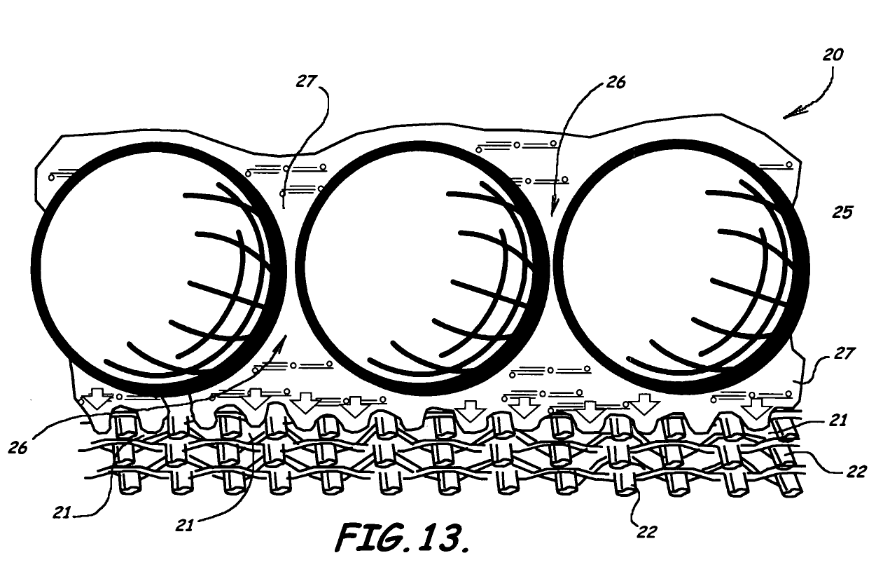

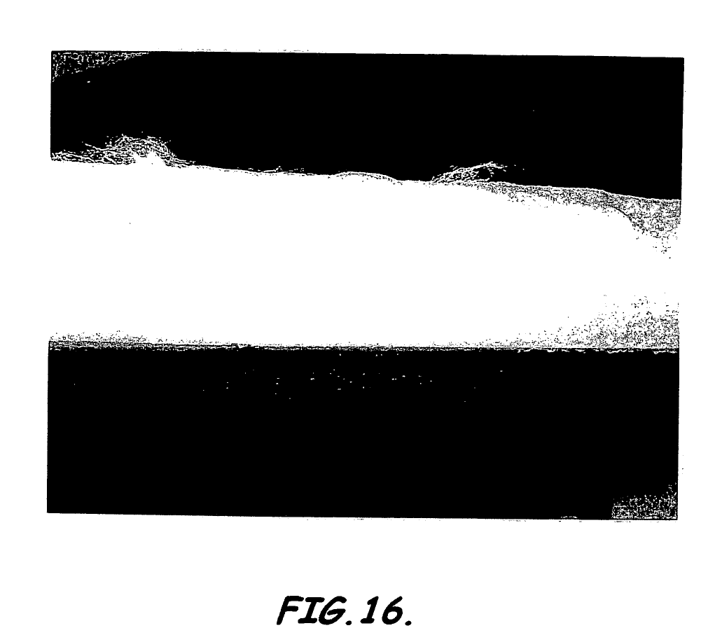

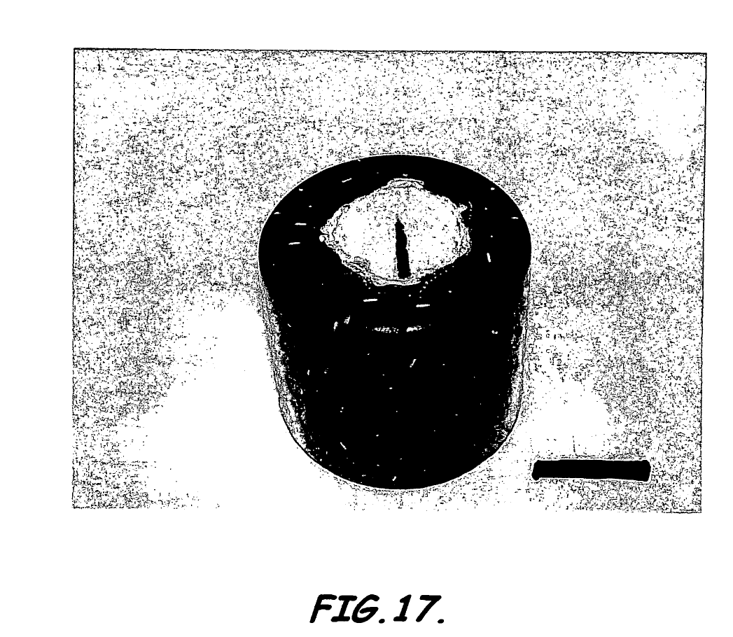

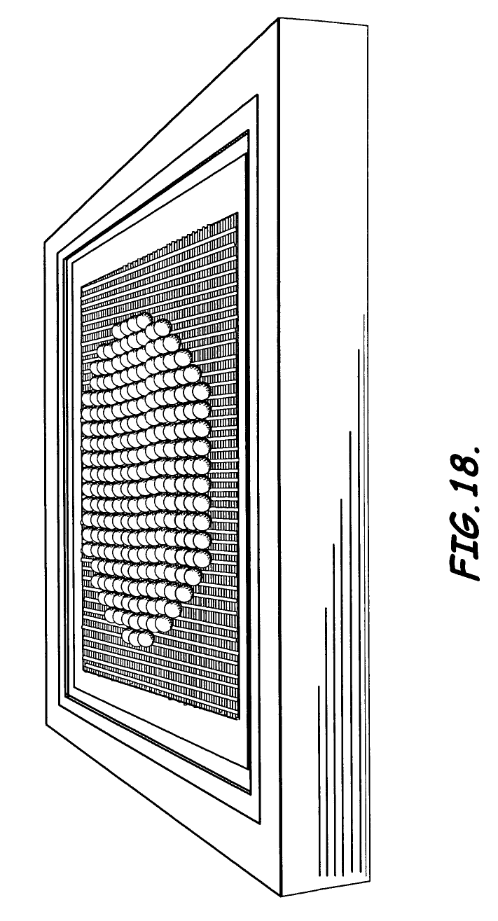

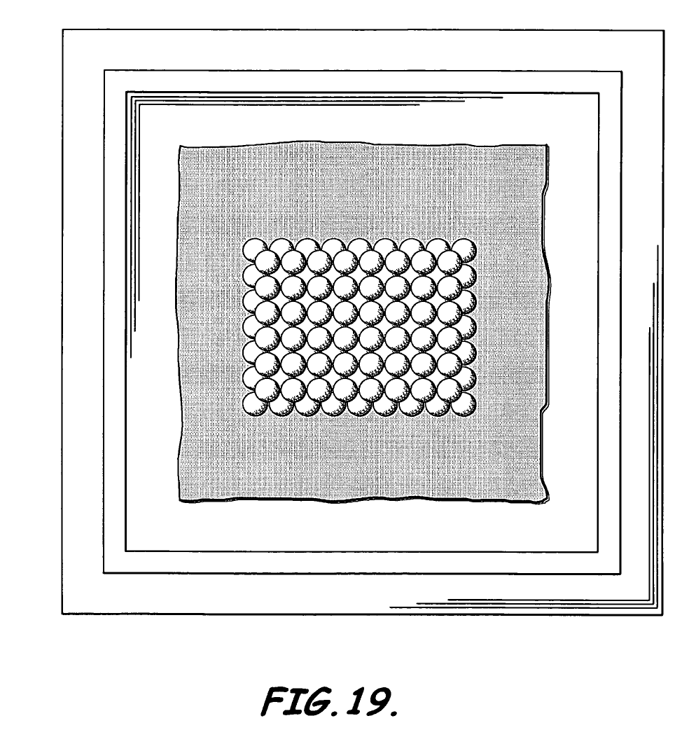

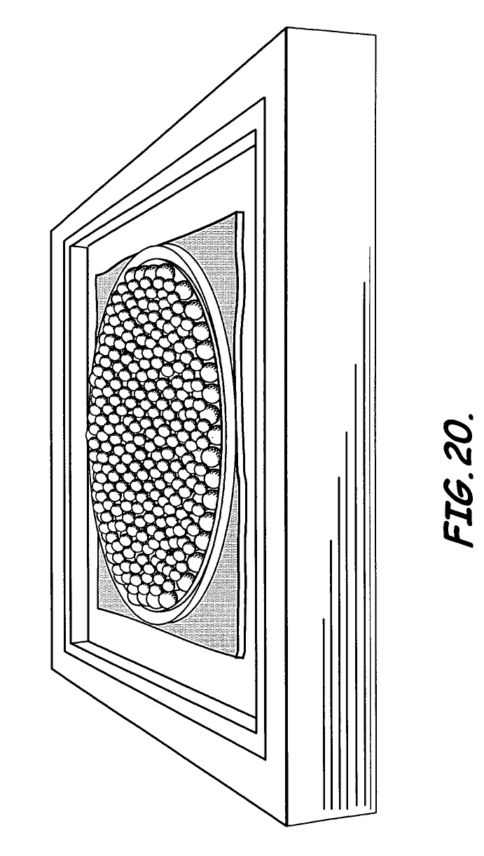

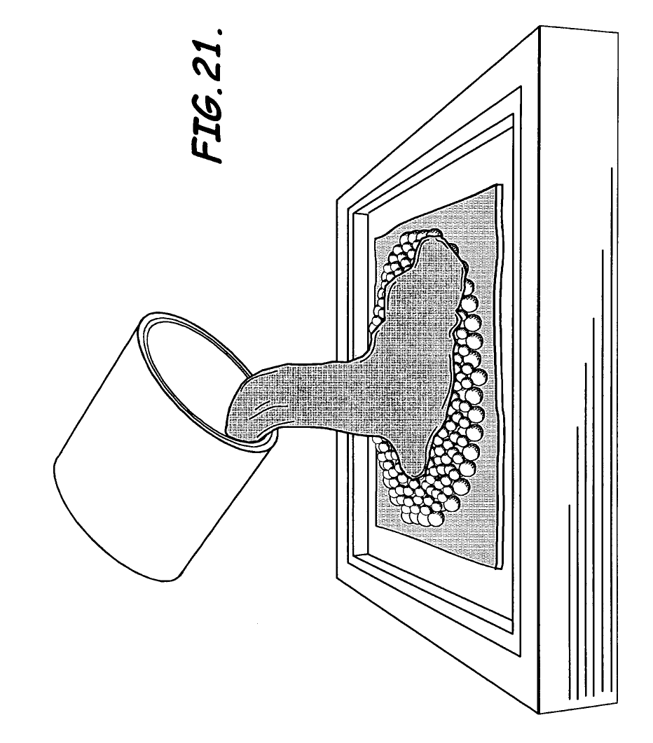

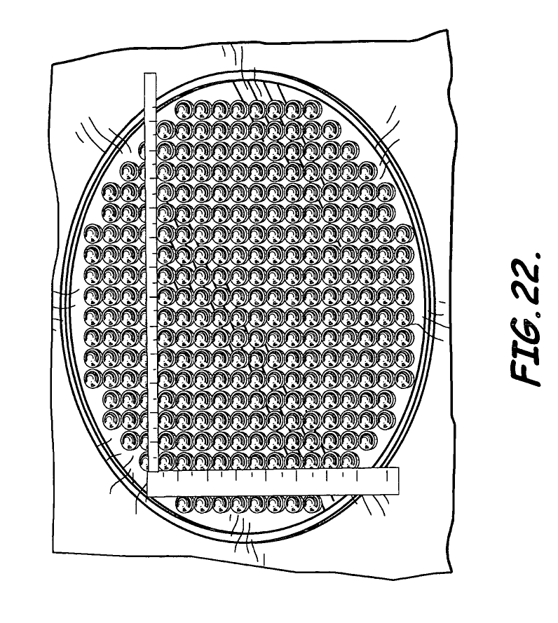

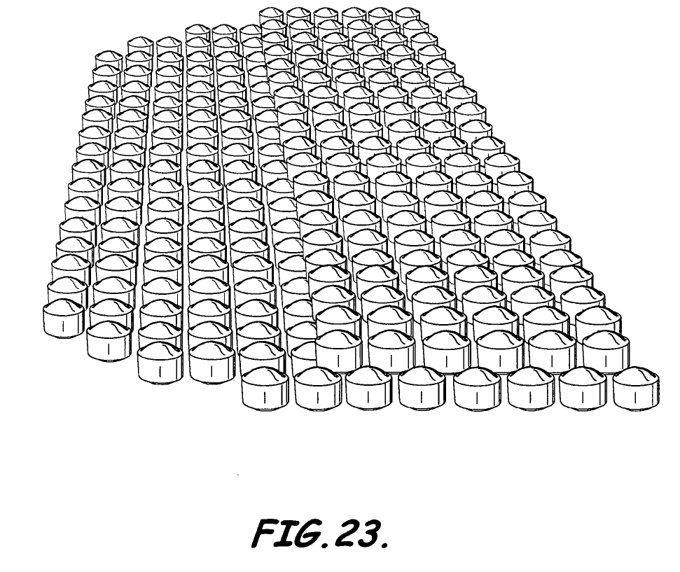

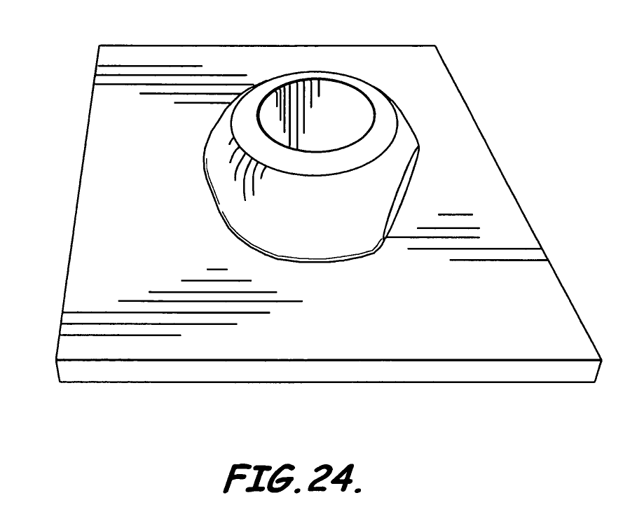

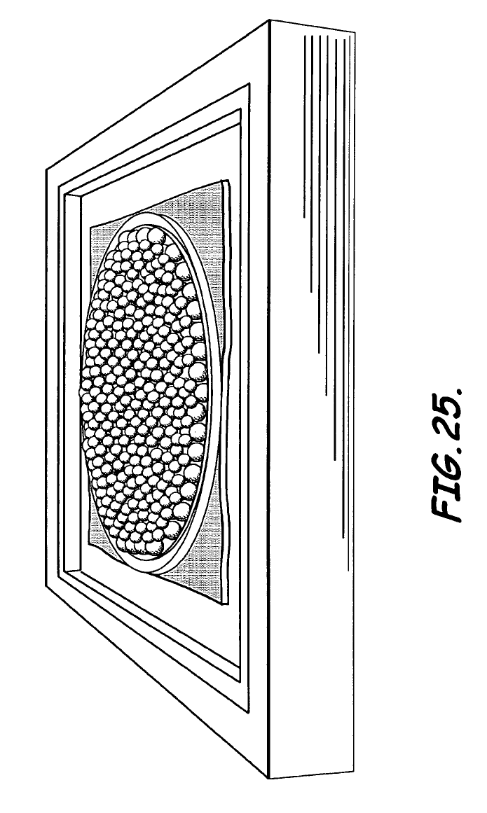

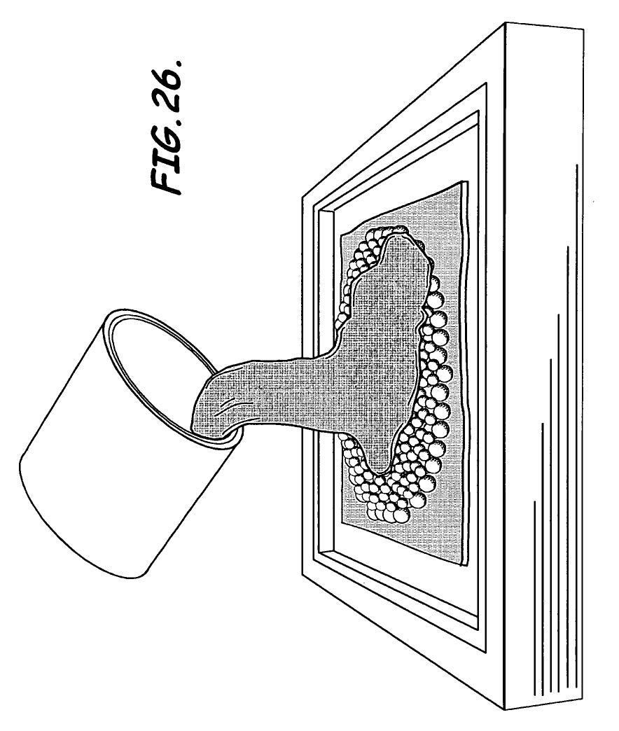

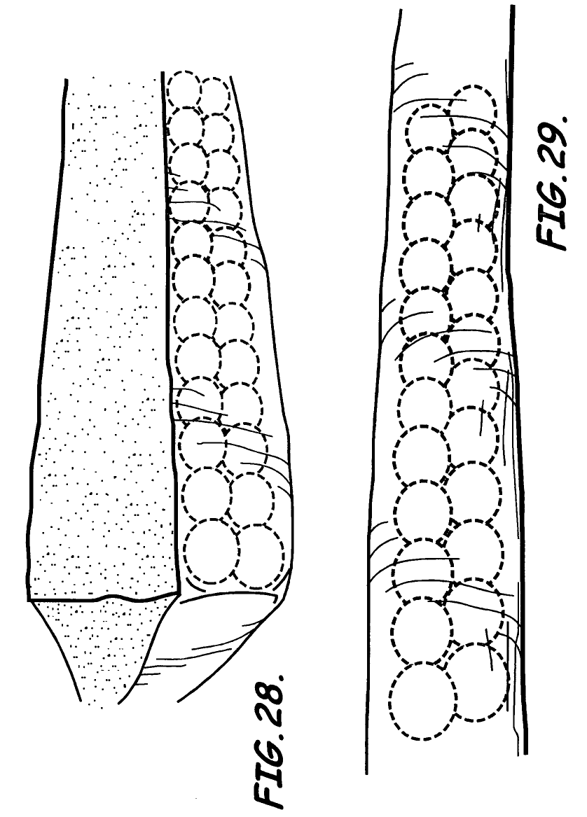

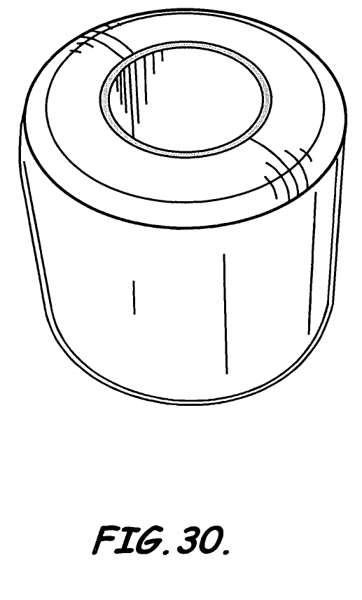

FIGS. 1-30 illustrate embodiments of a ballistic panel 20, 20′, 20″, 120, 220 or other structure, methods of forming a ballistic panel, methods of destroying a projectile P, P′ and other methods according to the present invention. These embodiments of a ballistic panel have a plurality of hard objects 25, 25′, 25″, 25a, 25b, 25c, 125, 225, e.g., preferably formed of ceramic material, alumina-oxide material, such as formed of alumina materials from CoorsTek, Inc. of Golden, Colo., or a boron carbide material, such as provided by Isaco, Inc. of Quakertown, Pa. or also CoorsTek, Inc., or other hard materials as understood by those skilled in the art, which each have or have been formed into a desired shape. The objects 25, e.g., spheres, half-spheres, pills, pellets, hexagons, or other shapes, for example, can be rotary pressed with an alumina content of 90% mixture or greater so that desired hardness is maintained and a more uniform spherical formation (or other formation shape) is achieved. Also, recycled, grinding media may also be used to form the spheres or other objects 25 to enhance hardness, reduce failure or fracture and yet make use of recycled product.

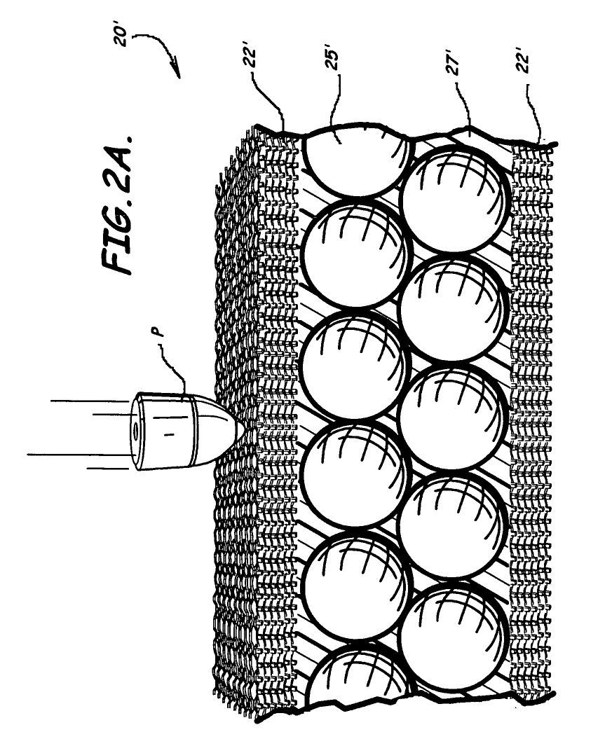

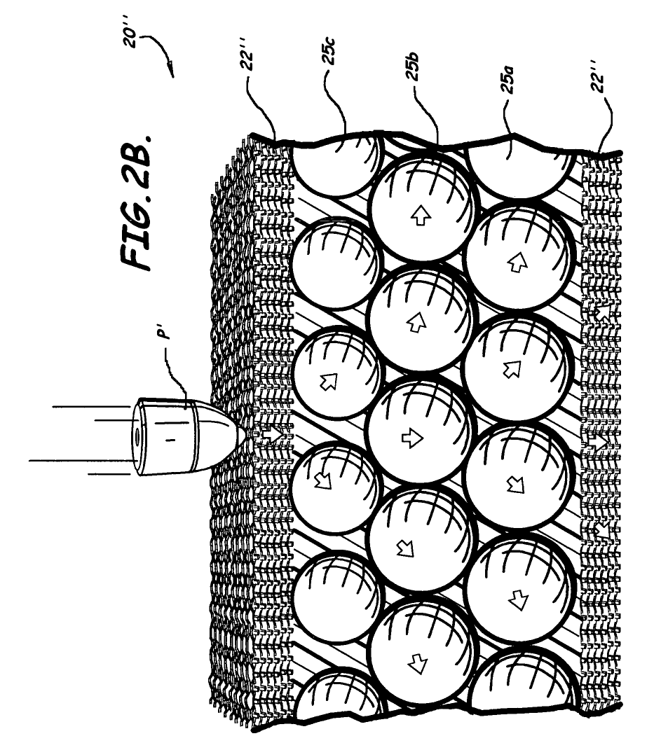

Spheres are primarily illustrated and described herein for conciseness and brevity, but as understood by those skilled in the art other shapes can be used as well according to the present inventions of these other shapes, it is more preferable that the surface through which a projectile P (see FIG. 2A) enters the structure has an accurately shaped surface. Additionally, the structure is illustrated and described primarily as a panel for conciseness and brevity, but as understood by those skilled in the art other structures can be formed as well according to the present invention.

The plurality of spheres or other objects 25 (see, e.g., FIGS. 1, 2A, and 2B), for example, are encased or surrounded with resin or resin material 27 in between gaps 26 between spheres 25 and between layers of spheres 25. The spheres 25, for example, advantageously can be arranged in an optimum or preselected angular position. The spacing and angular position will be dependent on the size, e.g., diameter, of the spheres 25. To obtain an optimum arrangement, for example, a tight nesting or packing of the spheres 25 can be formed or used.

For example, consistently and tightly nesting or packing each of the plurality of substantially solid objects, e.g., spheres, half-spheres, pills, and pellets, in one or more layers in embodiments of panels, structures, and related methods, enhanced performance characteristic for destroying and/or reducing the energy of projectiles can be achieved in a more cost effective manner. Also, for example, by using woven fabric layers and polymeric resin in embodiments, weight can be substantially reduced for many protective applications. Further, for example, the hollow microspheres or other hollow objects, or micro-objects, can also further reduce the weight of embodiments of a panel or structure according to the present invention. A half-sphere, for example, can reduce thickness or height of a panel or structure, as well a pill or pellet shape (larger diameter than height or thickness) such as having a smooth outer surface like a coated medicine pill or piece of candy. The half-sphere and pill or pellet shape can be achieved with ceramics using techniques understood by those skilled in the art.

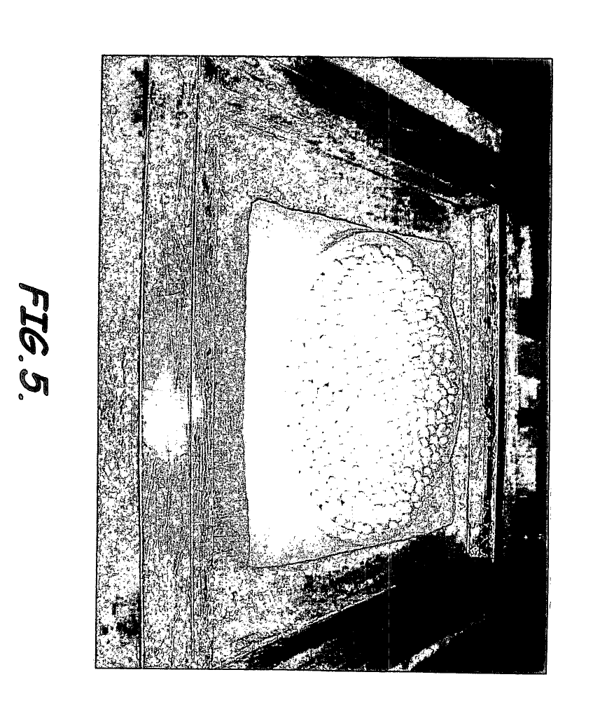

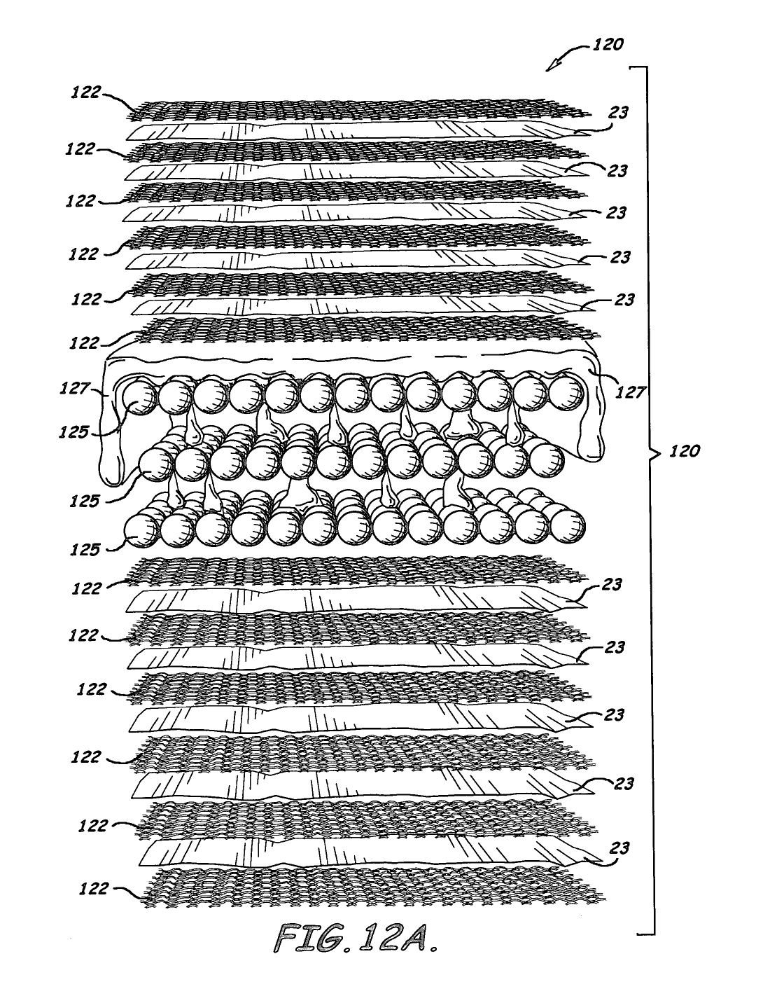

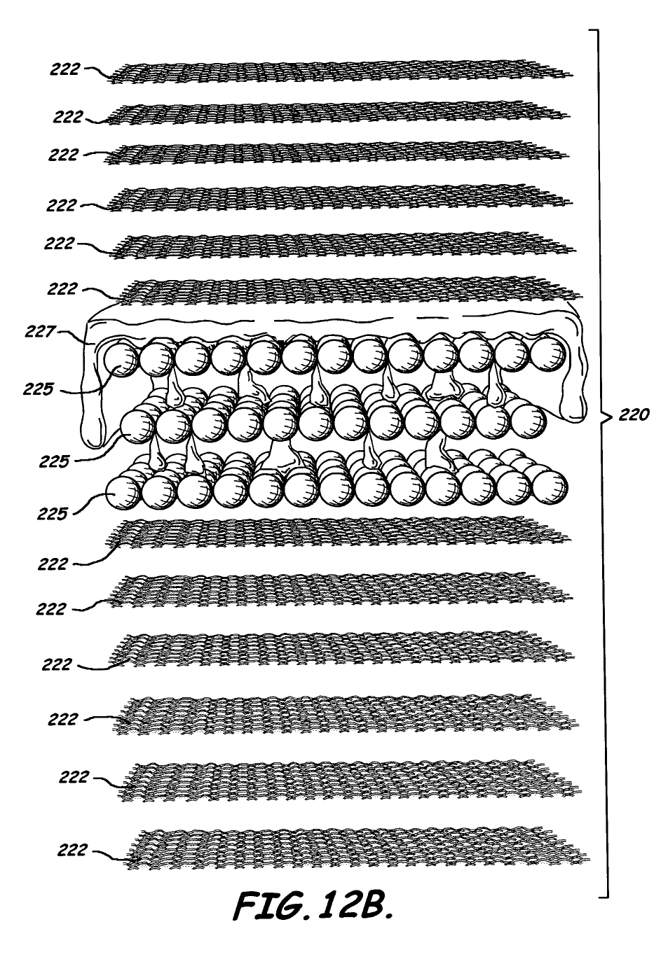

In forming an embodiment of a panel 20, for example, about 3 to 20 layers, e.g., 14 layers, of a woven fiber fabric material 22, e.g., Aramid fiber fabric such as Kevlar, Twaron, Spectra, or DSM Dyneema, can first be laid or positioned in a mold (see, e.g., FIGS. 5, 7-10, 20, and 22-25). The fabric layers 22 can be bonded together using a film laminate 23 (see FIG. 12A), e.g., polyethylene, formed of a thermoplastic material and heat pressed into bond the layers, pre-impregnation by soaking the fabric material 22 in urethane material to about 33% saturation content (see FIG. 12B) and then pressed at 3,000 to 30,000 pounds per square inch depending on the application, or other techniques as understood by those skilled in the art. As shown in FIG. 1, at least a first layer (for a single layer panel) of spheres 25 (e.g., solid, ceramic spheres), and can also include adding a plurality of micro-spheres (e.g., smaller hollow beads or particles such as used in filler applications) to be used with the resin (see FIG. 2B), to lighten the resin, further insulate, increase a crush factor or control density, and enhance fire retardency, is then positioned to overlie or be adjacent the woven fiber material 22. The spheres 25, for example, can be held in place by or with gravity (such as at a slight angle), vibration into a tight retainer or mold, or vacuum or other pressure.

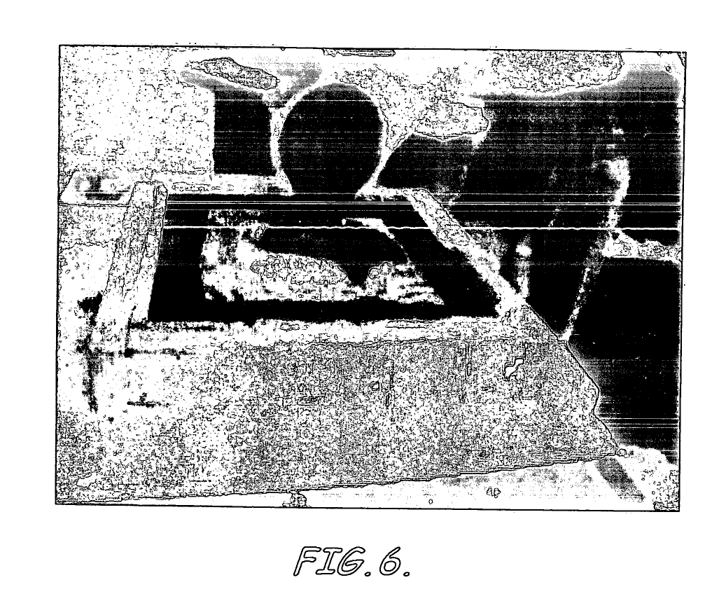

Although some two-layer spherical arrangements (see, e.g., FIG. 2A) can be used, preferably three or more layers of objects, i.e., spheres, half-spheres, pills, pellets, hexagon, micro-spheres, micro-objects, and/or other shapes (see, e.g., FIG. 2B) are used for armor piercing ballistic applications. One layer (see, e.g., FIG. 1), however, can be used also, for example, in some protective applications with less effectiveness for high-energy impact application. A resin 27 or resin material, such as described in U.S. Pat. No. 6,026,760, can then be poured into the mold in gaps 26 or spaces between spheres 25, e.g., as a type of filler material (see FIGS. 6, 11, 21, and 26), and overlying (and underlying) the spheres to hold the spheres in place. The resin 27, for example, can be a urethane resin or other air content closed-cell type or open-cell-type resin as understood by those skilled in the art. Although a single component resin can be used, the resin 27 is preferably a two-component resin, as understood by those skilled in the art that uses an exothermic-type process to solidify or cure. Alternatively, for example, a polyethylene glycol or liquid armor, such as from the U.S. Army Research Laboratory, as understood by those skilled in the art, may be used as well instead of the resin material. For embodiments using a resin or resin material, heat then can be applied to the resin 27, sphere 25, fabric 22 combination 20, and additional layers 22 of woven Aramid fabric material, if desired, can be immediately added as well, prior to or during the heat, e.g., exotherming process at about 200 degrees Fahrenheit as understood by those skilled in the art, so as to overlie or be adjacent the spheres/resin.

The spheres 25 or other objects are preferably packed tightly so as to contact adjacent spheres in one or more layers. Additional layers can advantageously overlie gaps 27 in an underlying or adjacent layer. The distance or spacing between layers of spheres 25, especially with tight packing to contact adjacent spheres, enhances the spread of energy when a projectile enters a panel 20 and the fabric material 22 reduces the back plate deflection of the projectile. If more than one layer of spheres 25 are used, e.g., two layers, then advantageously less layers of Kevlar or fabric material, e.g., 6 layers, can be used (see FIG. 2A). Increasing the layers of spheres 25 enhances ballistic protection, but also increases the weight. Hence, depending on the application, it will be understood by those skilled in the art that various arrangements of spheres 25 or other objects, resin 27, and fabric 22 can be selected according to embodiments of panels or other structures of the present invention.

For armor piercing projectiles P, P′ (see FIGS. 2A-2B) or ballistics, for example, embodiments of multiple layers of a plurality of objects 25, 25′, 25″, 125, 225, e.g., spheres, half-spheres, pills, pellets, hexagons, or other shapes, including an oblong-type shape, in a ballistic panel 20 or other structure can advantageously be used to more effectively spread the energy received from such a projectile. A second and third layer of objects 25 can be added to stepwise increase or enhance protectiveness of the panel. Also, as layers of the objects 25 are increased, layers of fabric material 22 can be decreased. For example, in an embodiment of a single spherical layer of a ballistic panel 20 (see FIG. 1) according to the present invention, 14 layers of woven fabric material 22, such as Kevlar, Twaron, Spectra or other Aramid fiber-type of material, can be used. On the other hand, if two spherical layers are used in an embodiment of a ballistic panel 20 (see FIG. 2), then only 6 layers of woven fabric material 22 can be used.

Another embodiment of a ballistic panel according to the present invention includes a plurality of fabric layers 22′ of woven fiber material (see FIGS. 2A-2B and FIGS. 28-29). The plurality of fabric layers 22 also includes an innermost layer having spacing between fibrous strands of fabric as understood by those skilled in the art. The panel 20′ also includes at least one layer of a plurality of substantially solid objects positioned adjacent the innermost layer of the plurality of fabric layers. The plurality of objects 25′ being positioned in each layer so that spacing occurs between each of the plurality of objects. The panel 20′ further includes a polymeric material positioned in the space between each of the plurality of objects 25′ and the spacing between fibrous strands of and contacting the innermost layer.

In this embodiment, the plurality of fabric layers 22′ can include a first plurality of fabric layers, and the panel 20′ can also include a second plurality of fabric layers 22 of woven fiber material positioned to overlie the polymeric material and the plurality of objects 25. At least one of the second plurality of fabric layers 22 also contacts the polymeric material. Each of the plurality of substantially solid objects 25 is preferably formed of a ceramic, alumina, or boron-carbide material, and more advantageous the at least one layer of a plurality of spherical-shaped objects 25 has at least two layers. The polymeric material 27′ retains each of the plurality of spheres 25 in a relatively fixed position as illustrated.

Advantageously, also the first plurality of fabric layers 22′ can be at least three layers, and more preferably at least six layers. The second plurality of fabric layers 22′ also can be at least three layers. The polymeric material 27′ can be a urethane material or other material advantageous for desired applications. Each of the first plurality of fabric layers 22′ includes a thermoplastic laminate to assist in adhesively connecting each of the first plurality of fabric layers with at least one other fabric layer of the first plurality of fabric layers 22′, and each of the second plurality of fabric layers 22′ includes a thermoplastic laminate to assist in adhesively connecting each of the second plurality of fabric layers with at least one other fabric layer of the second plurality of fabric layers. As described, each of the plurality of objects 25′, 25″ is formed of a material selected from the group of: alumina, boron carbide, and ceramics, and the polymeric material advantageously can be a two-component cured resin including urethane.

The plurality of spherical shaped objects 25, 25′, 25a, 25b, 25c is each substantially solid and each have substantially the same diameter in some of these embodiments. Each of the first and second plurality of woven fabric layers 22′, 22″ includes an innermost woven fabric layer positioned closest to the at least one layer of plurality of objects and having spacing between fibrous strands of fabric, and the polymeric material 27′ (although other types of materials can be used as well in addition to or in substitute for the polymeric material in some types of structures according to the present invention is positioned within the spacing of the innermost woven fabric layer of each of the first and second plurality of fabric layers. As an alternative to the laminate in the fabric layers, each layer of the first plurality of fabric layers can include pre-impregnated urethane material to enhance adhesiveness between an adjacent layer of the first plurality of fabric material, and each layer of the second plurality of fabric layers, if used, can also include pre-impregnated urethane material to enhance adhesiveness between an adjacent layer of the second plurality of fabric material.

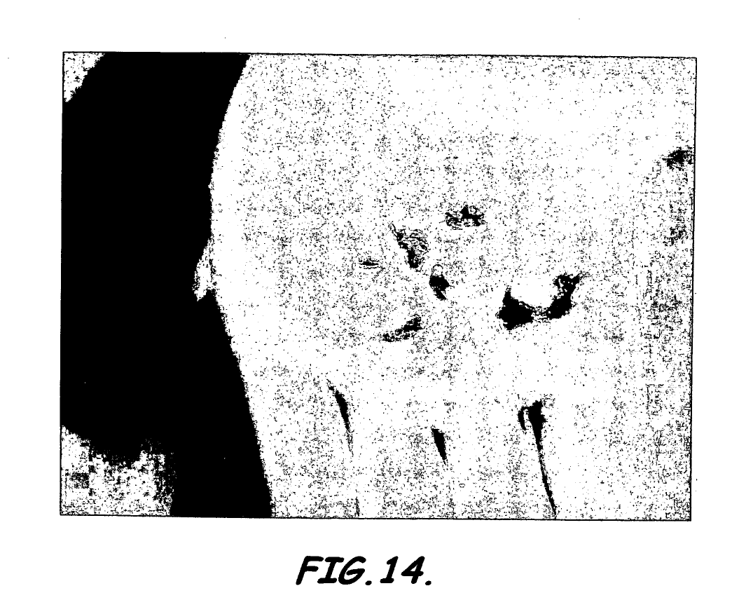

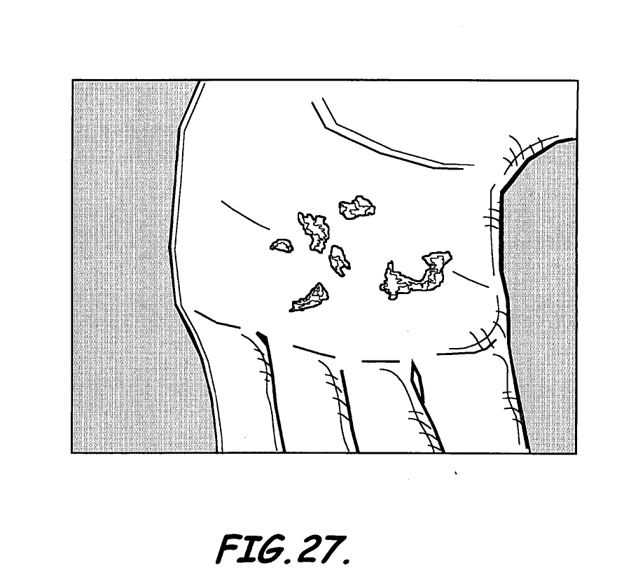

In operation, at the initial stages of impact, a projectile P enters a panel 20′ (see, e.g., FIG. 2A), according to an embodiment of the present invention, in a normal manner as understood by those skilled in the art. Conventional ballistic resistant fabrics or thin, high strength ceramic plates distort the leading end of the projectile and increase the projectile drag as the projectile enters the panel. Upon entry into geometric zones, the projectile P is turned by the deflecting surfaces. As it continues along the path, the initially turned leading end is deflected into other paths while the trailing end has not yet experienced the torque action of the shock waves in the projectile body. A front portion of the projectile P begins to disintegrate, clearing the way for a rear section thereof to be deflected along similar reverse torque paths until the projectile is finally totally destroyed (see, e.g., FIGS. 14 and 27), and comes to rest in the geometric layer.

For example, in initial tests, both 7.62 mm by 39 mm Russian and 0.3006″ armor piercing (“AP”) United States rifle ammunition were destroyed at 15 meters distance and less, without the use of ceramic front plate facings on the armor package. Both ammunition types were destroyed in multi-hit test conditions. An embodiment of a ballistic panel, for example, can have an effective temperature range of minus 50 degrees Fahrenheit to plus 350 degrees Fahrenheit.

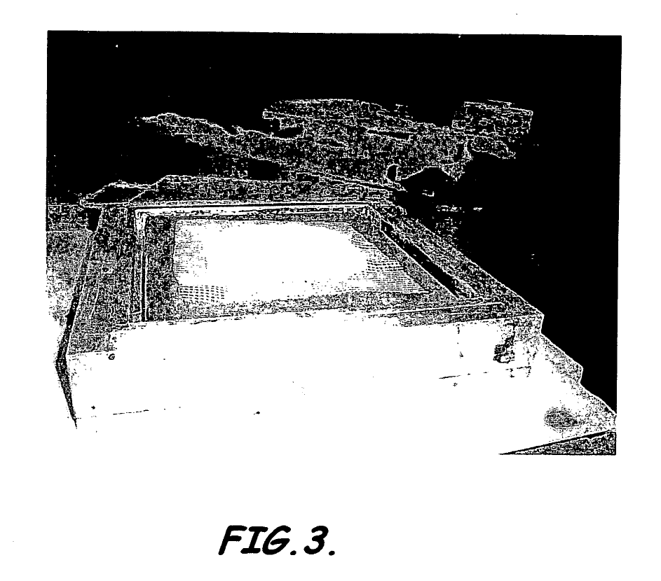

An embodiment of a method of forming a ballistic structure, for example, includes positioning a plurality of woven fabric layers 22, 22′, 22″ in association with a mold and positioning at least one layer of a plurality of substantially solid objects to overlie and contact the plurality of fabric layers (see FIGS. 3-11 and 18-26). The plurality of objects 25, 25′, 25a, 25b, 25c preferably are tightly packed but positioned in each layer so that spacing 26 occur between each of the plurality of, e.g., spherical-shaped objects. The spacing can be the result of a separation between adjacent objects such as, for example, when the objects are positioned separate and spaced apart from each other; due to gaps formed between portions of adjacent contacting objects due to a non-planar shape of such objects; or a combination thereof. The method also includes positioning a polymeric resin material 27, 27′ in the spacing between each of the plurality of spherical-shaped objects and to contact at least an innermost layer of the plurality of woven fabrics and heating the resin material to thereby cure the resin material. Note, according to an embodiment of the method, the polymeric resin is poured in the space or spacing between each of the plurality of objects.

The method can also include immediately positioning another or second plurality of fabric layers of woven fiber material to overlie the polymeric material and the plurality of shaped objects 25 prior to or during the step of heating. The first plurality of fabric layers 22′ preferably is at least three layers, the second plurality of fabric layers 22′ preferably is at least three layers, and the polymeric material 27′ preferably includes a urethane material. The plurality of objects 25 can be formed of a ceramic, alumina, boron carbide or other hard material, for example. The at least one layer of a plurality of objects 25′ is preferably at least two layers in many applications, and the polymeric material 27′ retains each of the plurality of objects 25′ in a relatively fixed position. Also, each of the plurality of objects 25 are retained in a position by vacuum pressure prior to positioning of the polymeric resin material, and the step of heating includes exotherming the resin material responsive to at least two components in the resin material reacting to thereby generate heat.

Additionally, if desired, testing of the quality of the hardened objects (e.g., spheres, half-spheres, pills, pellets, hexagons, or other shapes) can be used or added in the manufacturing process of forming the objects so that cracks or defects can be detected as will be understood by those skilled in the art.

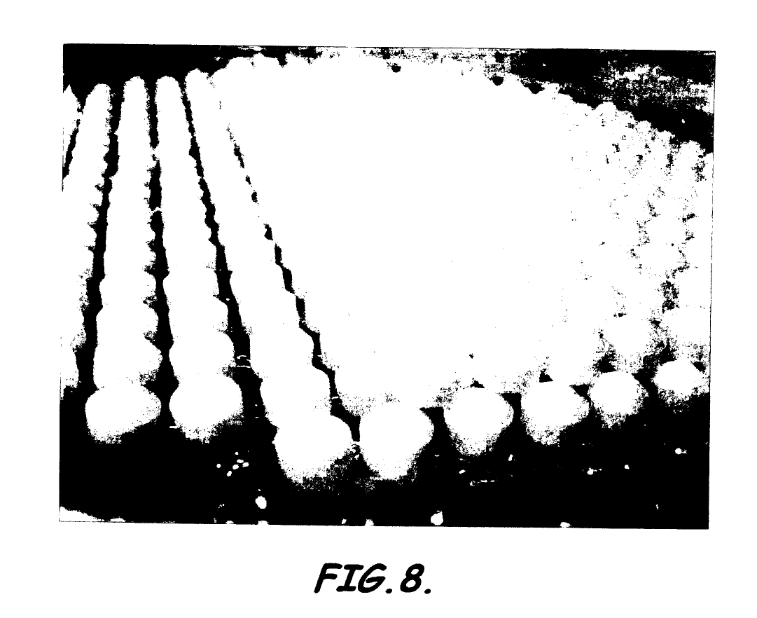

The forming of a panel or other structure, for example, can be in a one-step process with the fabric layers such as in a mold (see FIGS. 8-9, 17, 23-24, and 30). Alternatively, for example, the forming can be in two or more steps where the resin and spheres (or other objects) combination is first formed and then the fabric layers are adhesively adhered to the resin and spheres combination as will be understood by those skilled in the art.

Embodiments of a method of forming a ballistic structure 20 (see, e.g., FIGS. 1-30) advantageously can include positioning at least one layer of a plurality of objects 25, 25′, 25a, 25b, 25c in a mold (see, e.g., FIG. 3-6 and 18-21). Each of the plurality of objects have an arcuate surface facing a region toward which a projectile P is to enter the structure 20, 20′, 20″ (see FIGS. 1, 2A, and 2B) to thereby define a projectile entry region. The embodiment of a method can also include positioning material 27, 27′ to contact each of the plurality of objects and to substantially fill spacing adjacent each of the plurality of objects and hardening the material 27, 27′, e.g., prior to removal from the mold.

The method can also include positioning a plurality of fabric layers 22, 22′, 22″ along the projectile entry region to contact the arcuate surface of at least a set of the plurality of objects 25, 25′, 25a, 25b, 25c. The plurality of layers 22′, 22″ can be a first plurality of fabric layers, and the method can also include positioning a second plurality of fabric layers to overlie the material along a surface region opposing the projectile entry region. The plurality of objects 25, 25′, 25a, 25b, 25c, for example, can have a shape selected from the group of sphere, half-sphere, pill, pellet, oblong, hexagonal and polygonal. The shapes more preferably have the arcuate surface facing the projectile entry region, but can have other shapes along other portions of the object, e.g., hexagonal, polygonal, pill, pellet, around other portions.

The embodiment of a method can further include the material being a resin material, e.g., polymeric or other material, and the hardening can include heating the resin material to cure the material, and then cooling the structure 20, 20′, 20″ as understood by those skilled in the art. The at least one layer can be a plurality of layers of objects 25, 25′, 25a, 25b, 25c, e.g., two, three, or more layers, with spacing between adjacent ones of the plurality of objects. The objects can also be formed in a separate or second mold, see FIGS. 14 and 30. Such as from ceramics or other materials as described herein, prior to being positioned in the structure or first mold. Additionally, micro-objects, e.g., smaller and substantially hollow, can be positioned in spacing adjacent the plurality of objects which advantageously can be substantially solid.

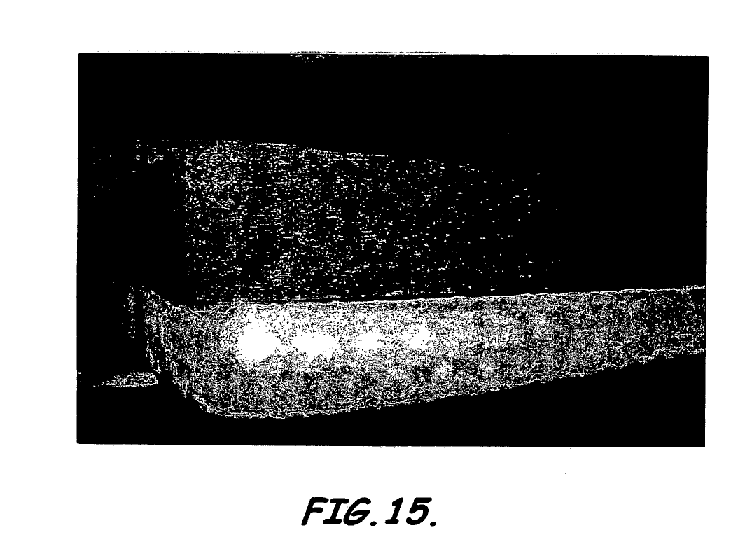

As illustrated in FIGS. 1-30, and particularly FIGS. 15-17, 28-30 and as described herein, it will be understood by those skilled in the art that embodiments of ballistic panels or other ballistic structures can have cylindrical, rectangular, tubular, or other types of shapes and arrangements and can be added to other energy impact reducing materials or products as well according to the present invention. As understood by those skilled in the art, embodiments of a ballistic structure according to the present invention can be a panel, a laminate, a cylinder, a tubular structure, a bore structure, a container, at least a portion of body armor, a helmet, a portion of a weapon launch assembly, pipelines, communication equipment, boxes, or structures, and other structures.

The present application is related to U.S. Provisional Patent Application Ser. No. 60/646,269 filed on Jan. 24, 2005 titled “Ballistics Panel, Structure, and Associated Methods” and which is incorporated herein by reference in its entirety. The present application is also related to co-pending U.S. Non-Provisional patent application Ser. No. ______ by the same inventors titled “Ballistics Panel, Structure, and Associated Methods” filed the same day as this application, and which is also incorporated herein by reference in its entirety.

In the drawings and specification, there have been disclosed embodiments of the invention and, although specific terms are employed, they are used in a generic and descriptive sense only and not for the purpose of limitation, the scope of the invention being set forth in the following claims.

That claimed is:

1. A method of forming a ballistic panel, the method comprising:
positioning a first plurality of fabric layers of woven material in association with a mold;
positioning at least one layer of a plurality of substantially solid objects to overlie the first plurality of fabric layers, the plurality of objects being positioned in each layer so that space exists between each adjacent one of the plurality of substantially solid objects;
positioning a polymeric resin material in the space between each of the plurality of substantially solid objects;
heating the resin material; and
positioning a second plurality of fabric layers of woven material to overlie the polymeric material and the plurality of substantially solid objects.

2. A method as defined in claim 1, wherein the first plurality of fabric layers comprises at least three layers, wherein the second plurality of fabric layers comprises at least three layers, and wherein the polymeric material comprises a urethane material.

3. A method as defined in claim 2, wherein the plurality of substantially solid objects comprises a ceramic material, wherein at least one adjacent pair of objects of the plurality of substantially solid objects is positioned in contact with each other, wherein the at least one layer of a plurality of substantially solid objects comprises at least two layers, and wherein the polymeric material retains each of the plurality of substantially solid objects in a relatively fixed position.

4. A method as defined in claim 1, wherein each of the plurality of substantially solid objects are retained in a position by vacuum pressure prior to positioning of the polymeric resin material.

5. A method as defined in claim 1, wherein the step of heating includes exotherming the resin material responsive to at least two components in the resin material reacting to thereby generate heat.

6. A method of forming a ballistic structure, the method comprising:
positioning a plurality of fabric layers of woven fiber material in association with a mold;
positioning at least one layer of a plurality of substantially solid objects to overlie and contact the plurality of fabric layers, the plurality of substantially solid objects being positioned in each layer so that space exists between each of the plurality of substantially solid objects and being retained in position by vacuum pressure;
positioning a resin material in the space between each of the plurality of substantially solid objects and to contact at least an innermost layer of the plurality of fabric layers; and
heating the resin material to thereby cure the resin material.

7. A method as defined in claim 6, wherein the plurality of fabric layers comprises a first plurality of fabric layers, wherein the resin material comprises a polymeric material, and wherein the method further comprises immediately positioning a second plurality of fabric layers of woven fiber material to overlie the polymeric material and the plurality of substantially solid objects prior to or during the step of heating.

8. A method as defined in claim 7, wherein the first plurality of fabric layers comprises at least three layers, wherein the second plurality of fabric layers comprises at least three layers, wherein the polymeric material comprises a urethane material, and wherein the plurality of substantially solid objects comprise one or more of a spherical shape, half-sphere shape, pill shape, pellet shape, oblong shape, hexagon shape, and polygon shape.

9. A method as defined in claim 6, wherein the plurality of substantially solid objects comprises a ceramic material, wherein the at least one layer of a plurality of substantially solid objects comprises at least two layers, and wherein the polymeric material retains each of the plurality of objects in a relatively fixed position.

10. A method as defined in claim 9, wherein at least one adjacent pair of objects of the plurality of objects is positioned in contact with each other, and wherein each of the plurality of substantially solid objects are retained in position by the vacuum pressure prior to positioning of the polymeric resin material.

11. A method as defined in claim 10, wherein the step of heating includes exotherming the resin material responsive to at least two components in the resin material reacting to thereby generate heat.

12. A method of forming a ballistic structure, the method comprising:
positioning at least one layer of a plurality of objects in a mold, each of the plurality of objects having an arcuate surface facing a region toward which a projectile is to enter the structure to thereby define a projectile entry region;
positioning material in the mold to contact each of the plurality of objects and to substantially fill space adjacent each of the plurality of objects; and
hardening the material including heating the material through an exothermic process, responsive to at least two components in the material reacting to thereby generate heat.

13. A method as defined in claim 12, further comprising positioning a plurality of fabric layers along the projectile entry region to contact the arcuate surface of at least a set of the plurality of objects.

14. A method as defined in claim 12, wherein at least one adjacent pair of objects of the plurality of objects is positioned in contact with each other, and wherein the material comprises a resin material.

15. A method as defined in claim 13, wherein the plurality of fabric layers comprises a first plurality of fabric layers, and the method further comprises positioning a second plurality of fabric layers to overlie the material along a surface region opposing the projectile entry region.

16. A method as defined in claim 12, wherein the plurality of objects have a shape selected from the group of sphere, half-sphere, pill, pellet, oblong, hexagonal, and polygonal, and wherein each of the plurality of objects contact an adjacent one of the plurality of objects prior to positioning of the material in the mold.

17. A method as defined in claim 12, wherein the at least one layer of a plurality of objects comprises at least two layers of a plurality of objects, and wherein space is positioned between adjacent ones of the plurality of objects and between each of the at least two layers of a plurality of objects.

18. A method as defined in claim 12, wherein the mold comprises a first mold, and the method further comprises forming each of the plurality of objects in a second mold prior to positioning the plurality of objects in the second mold.

19. A method as defined in claim 18, wherein the plurality of objects comprises a ceramic material, and wherein the material retains each of the plurality of objects in a relatively fixed position prior to entry of a projectile into the structure.

20. A method as defined in claim 12, wherein the plurality of objects includes a first plurality of substantially solid objects and a second plurality of smaller and substantially hollow objects defining micro-objects.
